(19) United States
(12) Patent Application Publication
(10) Pub. No.: US 2002/0038446 A1
(43) Pub. Date: Mar. 28, 2002

(54) Gate extractor

(75) Inventor: Alexei Ioudovski, Nepean (CA)

Correspondence Address: STERNE, KESSLER, GOLDSTEIN & FOX PLLC, 1100 NEW YORK AVENUE, N.W., SUITE 600, WASHINGTON, DC, 20005-3934, US

(73) Assignee: Gate Extractor

(21) Appl. No.: 09/920,843

(22) Filed: Aug. 3, 2001

(30) Foreign Application Priority Data
Aug. 9, 2000 (CA) 2,315,552

(51) Int. Cl. G06F 17/50

(52) U.S. Cl. 716/3; 716/4

(57) ABSTRACT

A computer process for extracting logic gates and/or functional cells from a transistor netlist. The process comprises the steps of scanning the netlist for transistor blocks of p-type and n-type transistors, determining if the p-type transistors and the n-type transistors are complementary or non-complementary and identifying the logic gate for each of the complementary transistor blocks and/or the functional cell for each of the non-complementary blocks. A transistor block is a group of p-type transistors connected through their sources and drains between a power node and a common node, and a group n-type transistors connected through their sources and drains between a ground node and the common node. Complementarity may be determined by iteratively seeking the serial connections and the parallel connections for the p-type transistors and the n-type transistors, identifying the main p-type transistor branch and the main n-type transistor branch, and comparing the branches.

### CROSS-REFERENCE TO OTHER APPLICATIONS

This application claims the benefit of the Canadian Patent Application Serial No. 2,315,552, filed Aug. 9, 2000.

Furthermore, the following applications of common assignee are related to the present application, have the same filing dates as the present application, and are incorporated by reference herein in their entireties:

“Advanced Schematic Editor”, Attorney Docket No. 0811.1220000; and

“Schematic Organization Tool”, Attorney Docket No. 0811.1230000.

### FIELD OF THE INVENTION

The invention relates generally to design analysis, and more particularly to a tool for identifying logic gates and similar cells in a transistor layout.

### BACKGROUND OF THE INVENTION

In the intensely competitive field of microelectronics, detailed analysis of a semiconductor integrated circuit product can provide valuable information as to how a particular technical problem was addressed, overall strengths and weaknesses of a design approach, and such matters. This information can be used to make decisions regarding market positioning, future designs, and new product development. The information produced from analysis of the product is typically provided through circuit extraction (reverse engineering), functional analysis, and other technical means. At the core of this activity is the process of design analysis which, in this context, refers to the techniques and methodology used to derive a complete or partial set of schematics from any type of integrated circuit manufactured using any process technology. For such technical information to be of strategic value it must be accurate and cost effective, and it is very important that the information should generated in a timely manner.

A design analysis process typically involves skilled engineers manually extracting circuit information from a set of large “photomosaics” of an integrated circuit (IC). Skilled technicians and engineers perform the following sequential tasks:

(1) A high magnification image of a small portion of an IC is captured using a camera or an electron microscope such as a SEM. The IC has been processed to expose a layer of interest.

(2) Step (1) is repeated for all of the various regions of interest of the layer of the IC, ensuring that sufficient overlap exists between adjacent images that will be used to create the photomosaics.

(3) Create Photomosaics: all adjacent photographs associated with the given IC layer are aligned and taped together.

(4) Steps (1)-(3) are repeated for every layer necessary to construct a layout database of the IC. All layers include interconnect layers. For example, four sets of photomosaics are required for a device with three layers of metal and one layer of polysilicon.

(5) Circuit Extraction: transistors, logic gates, and other elements employed in the IC are identified by manually, visually examining the polysilicon and lower metal interconnects photomosaics. Interconnections between circuit elements are traced and this information is captured in the form of schematic drawings. The drawings are manually checked against the photomosaics and any obvious errors are corrected.

(6) Organize Schematics: the schematic drawings are organized into hierarchical functional/logical blocks.

(7) Capture Schematics: the schematic drawings are entered into a computer using computer aided engineering (CAE) software tools for subsequent simulation and functional analysis of the IC.

The results of these substantially manual techniques for circuit extraction are often difficult to analyze. Difficulties arise in tracing signals that travel between several schematics. Locating the schematics associated with a particular signal can be very time consuming. During the circuit extraction process, signals are commonly given a generic name or label as a reference. Further analysis will reveal the purpose or function of these signals. The signals should then be renamed so that their name indicates their function. The signal renaming process creates two problems. Firstly, it takes some time to locate each schematic associated with a particular signal such that the signal can be relabeled on each schematic where it appears. Secondly, guaranteeing that the signal has been renamed on each schematic is difficult. This can result in inconsistencies with signal names that can confuse the engineer attempting to analyze the circuitry.

Another time consuming task associated with this manual circuit extraction process is the creation of signal and schematic lists. It is often useful to have a cross-reference between signal names and the name or number of the schematic in which these signals appear. However, such a cross-reference is very labor intensive to produce.

Once the schematics have been entered into a computer for simulation and/or subsequent analysis, it becomes difficult to edit the schematics. For example, as the circuit analysis progresses, it frequently becomes necessary to redraw certain schematics or to transfer portions of one schematic to another. Editing a set of schematics in such a way can often cause errors in the net list which require manual correction. Signal names and other labels on the revised schematics will also have to be manually changed.

Other than the manual method described above, the design analysis process can alternatively employ an automated circuit extraction process such as the one described in U.S. Pat. No. 5,694,481 which issued on Dec. 2, 1997 to Lam et al. Lam discloses an automated system for extracting design information from a semiconductor integrated circuit by imaging layers of an IC, creating a mosaic of the images, identifying the circuit elements, developing a basic net list of the circuit element connections, organizing the net list into functional blocks, and generating schematic diagrams.

Unfortunately, the circuit extraction method disclosed by Lam has the same restrictions as the manual method when in comes to locating signals and schematics, creating signal and schematic lists, and editing existing schematics. In fact, the automated method adds the burden of identifying logic gates and standard cells from a randomly organized net list. An engineer is required to sort through the schematics to convert the connected transistors into the relevant logic gates and standards cells. Obviously, this can take a very long period of time.

The results of these substantially manual techniques for circuit extraction are difficult to analyze since the resulting schematics are difficult to follow.

Therefore, there is a need for a tool which can assist in the generation of high level organized schematics that they may be properly and efficiently analyzed as to their functionality.

### SUMMARY OF THE INVENTION

The invention is directed to a process for extracting logic gates from a transistor netlist. The process comprises the steps of scanning the netlist for transistor blocks of p-type and n-type transistors, determining if the p-type transistors and the n-type transistors are complementary, selecting the complementary transistor blocks and identifying the logic gate for each of the complementary transistor blocks. A transistor block is a group of p-type transistors connected through their sources and drains between a power node and a common node and a group n-type transistors connected through their sources and drains between a ground node and the common node.

The scanning step may include selecting a transistor in the netlist having a source connected to a power or a ground node and finding the transistors in the p-type and the n-type transistor groups by tracing the transistor source/drain connections starting from the selected transistor.

Complementarity may be determined by iteratively seeking the serial connections and the parallel connections for the p-type transistors and the n-type transistors, identifying the main p-type transistor branch and the main n-type transistor branch, and comparing the branches. The branches may be compared by comparing an p-ID-string generated for the main p-type transistor branch and a n-ID string generated for the main n-type transistor branch in the transistor block.

Once it is determined that the transistor groups in a block are complementary, the logic gate may be identified by comparing at least one of the p-ID and n-ID-strings to the ID-strings of known logic-gates. Alternately, a netlist of each of the complementary transistor blocks may be generated and compared to netlists of known logic gates.

In accordance with another aspect of this invention, other functional cells may be extracted from the transistor netlist by identifying the cells in non-complementary transistor blocks. This may be done by generating a netlist for each of the non-complementary transistor blocks and comparing the non-complementary transistor block netlists to netlists of known functional cells.

In accordance with a further aspect of this invention, logic gate symbols may be generated to replace the complementary block transistors, and functional cell symbols may be generated to replace the non-complementary block transistors in a schematic.

In accordance yet another aspect of this invention, the process for extracting logic gates and other functional cells may be carried out by a computer system.

Other aspects and advantages of the invention, as well as the structure and operation of various embodiments of the invention, will become apparent to those ordinarily skilled in the art upon review of the following description of the invention in conjunction with the accompanying drawings.

### BRIEF DESCRIPTION OF THE DRAWINGS

The invention will be described with reference to the accompanying drawings, wherein:

FIG. 1 is a SPICE netlist of the transistor layout;

FIG. 2 is a flow chart of the branch identification process;

FIG. 3 illustrates a logic gate schematic in accordance with the present invention;

FIG. 4 illustrates the complementary transistor block of a C-MOS inverter;

FIG. 5 illustrates the inverter symbol;

FIG. 6 illustrates the complementary transistor block of a CMOS three input NOR gate;

FIG. 7 illustrates the three input NOR gate symbol;

FIG. 8 illustrates the complementary transistor block of a CMOS three input NAND gate;

FIG. 9 illustrates the three input NAND gate symbol;

FIGS. 10a, 10b, 10c and 10d illustrates the branches and sub-branches of a complementary transistor block of a complex CMOS logic gate;

FIG. 11 illustrates a symbol generated for the complex CMOS logic gate;

FIG. 12 illustrates the non-complementary transistor block of C-MOS tri-state device;

FIG. 13 illustrates the symbol generated for the tri-state device;

FIG. 14 illustrates a transistor connected as a capacitor;

FIG. 15 illustrates transistors connected as a Pass-Gate;

FIG. 16 illustrates the position of the x,y coordinates on a transistor; and

FIG. 17 illustrates a computer system for implementing the invention.

### DETAILED DESCRIPTION OF THE INVENTION

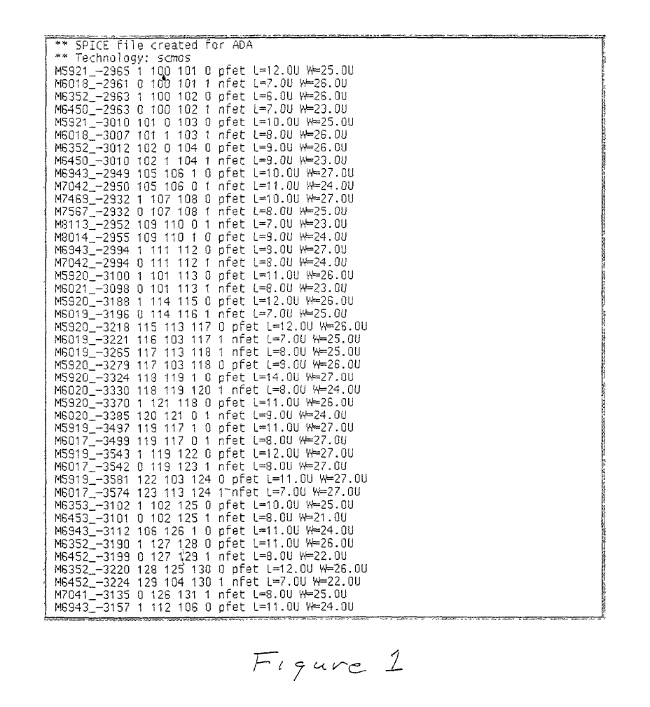

In copending application entitled Schematic Organization Tool filed on even date herewith by Gont et al and incorporated herein by reference, a novel process of generating a high level organized schematic of an integrated circuit (IC) is described. A commercial IC extraction tool such as “Magic” is normally used to identify the transistors in the layout and generate a transistor netlist such as the SPICE netlist consisting of the transistors and their connections. An example of the netlist is illustrated in FIG. 1. Each transistor in the netlist is characterized by the following:

a letter, in this case an “M” which identifies the element as a transistor;

a first set of 4 digits representing the “x” coordinate of the transistor;

a second set of 4 digits representing the “y” coordinate of the transistor;

a first binary number representing the signal at the transistor drain;

a second binary number representing the signal at the transistor gate;

a third binary number representing the signal at the source;

a fourth binary number which is a 0 for pfet's and a 1 for nfet's;

the term pfet or nfet to identify the type of transistor;

the length “L” of the transistor; and

the width “W” of the transistor.

This list is generated from the representation of the transistors identified in the IC by pattern recognition of the polysilicon crossing diffusion points.

Further in accordance with the copending application, cells consisting of meaningful groups of transistors are either selected from a library or are created by generating a cell schematic and a corresponding symbol. The netlists for the cells from either source are then used to search the transistor netlist to identify all identical cells in the circuit. The transistors from the identified cells are then replaced by the cell symbols from which a high level schematic can be generated.

The present invention provides an efficient manner for grouping the transistors into recognizable functional cells that are generally known as CMOS logic gates. Initially, the transistor netlist is scanned and the transistors are grouped into blocks. A block is defined as being a group of transistors having at least one transistor of each of the P-MOS and N-MOS types interconnected to one another only through their sources and drains between power and ground nodes. The gates of the transistors of each type are connected to input signals and the block has at least one output node which is usually connected to a gate in a further transistor block.

In the first step in the process of extracting Complementary Metallized-Oxide Semiconductor (CMOS) logic gates, the SPICE or transistor netlist is scanned to identify transistor blocks. This is done by selecting a first transistor of one transistor type that has a source connected to a power node or a ground node, and then a trace is made of source/drain (S/D) connections through a sequence of like transistors. The trace sequence is continued through all transistors whether they are in series and/or in parallel, is limited to transistors connected by source and/or drain nodes and does not extend to any transistor connected by its gate. The same process is repeated for all of the transistors of the other transistor type which have a common node connection with the first transistor type.

Logic gates have a hierarchical branch structure. Each gate has one main PMOS branch and one main NMOS branch. A main branch may be as simple as a single transistor or it may consist of a number of branches which themselves may include sub-branches. ID strings may be used to represent the hierarchy for each logic gate, however other ways can be used to identify the hierarchy.

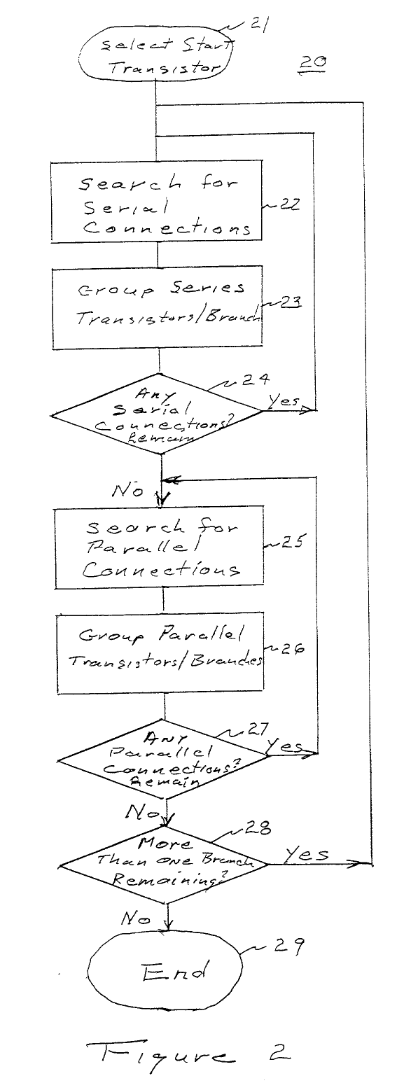

Once the netlist has been divided into transistor blocks through source/drain tracing, the reiterative process of branch identification begins. The branch identification process 20 is illustrated in the flow chart shown in FIG. 2. Initially a starting transistor type is selected from a block of transistors to be processed, it doesn't matter whether it is a PMOS type or NMOS type since both types will be processed.

a. Step 21—The first step illustrated in the flow chart in FIG. 2 is to select a start transistor. A start transistor has its source connected to a power node if it is a PMOS transistor or its source is connected to a ground node if it is an NMOS transistor.

b. Step 22—Beginning with the start transistor, a search is made for serially connected transistors/branches. A transistor serial connection is defined as the source of one transistor being connected to the drain of another transistor of the same type and with no other transistor connected to the node between two serial connected transistors.

c. Step 23—The transistors/branches connected to each other serially are grouped together as a branch.

d. Step 24—Are there any further serial connections remaining? If yes, step 22 is repeated; if no go to the next step 25.

e. Step 25—A search is made for parallel transistors/branches.

f. Step 26—The transistors/branches connected to each other in parallel are grouped together as a branch.

g. Step 27—Are there any further parallel connections remaining? If yes, step 25 is repeated; if no go to step 28.

h. Step 28—is there still more than one branch in the circuit of the one transistor type? If yes, step 22 is repeated, if no go to step 29.

i. Step 29—the main branch of the transistor type in question has been identified, the identification process ends.

This iterative process is then repeated for the other transistor type in the transistor block to identify the main branch of the other transistor type. Once the main branches for both transistor types have been identified, a check is done to determine whether the PMOS main branch and the NMOS main branch are complementary.

Complementary main branches signifies a CMOS logic gate.

Complementarity may be determined by representing the main branches by ID strings. The ID string indicates the transistor type, whether the transistors are in an OR formation having branches and/or sub-branches in parallel or in an AND formation having branches and/or sub-branches in series, and the number of branches in the parallel or series string of branches. The ID string further identifies the character of each of the branches, that is whether it comprises parallel or series branches, and the input signal label for each of the transistors.

In order to determine whether a transistor block is a CMOS logic gate, the P-ID string and the N-ID string of the block are compared. In order for the block to be a CMOS logic gate, the strings must be complementary or anti-symmetrical. This means that each input must be connected to at least one transistor of each type and to the same number of transistors of each type, and that the transistors of one type, PMOS or NMOS, in a branch of one type, series or parallel, must have common input signals as the transistors with the other type, NMOS or PMOS, in a branch of the other type, parallel or series. If all of the transistors meet this test, then the block represents a CMOS logic gate and may be replaced with a logic gate symbol with the appropriate inputs and outputs. The logic gate may be identified by comparing it to a logic gates in a library of gates and then the block of transistors may be replaced by the conventional logic gate symbol. If the block does not meet the test of having PMOS and NMOS transistors that are complementary or anti-symmetrical, the block is not a CMOS logic gate. This block can then be identified as a cell described by its own particular cell netlist and can be represented by some appropriate cell symbol.

The entire transistor netlist may be scanned to identify all of the transistor blocks in it. The blocks that have passed the CMOS logic gate tests may then be identified from a library through their ID string as discussed above or alternately the netlists of the blocks may then be compared to known logic gate netlists to identify them. To identify cells that have not passed the test, their netlists can be compared to known cell netlists for identification, or they can be given arbitrary names and symbols.

Structures such as tristate cells which include inverters, NAND's or NOR's have possible outputs of “0” “1” or simply “off”. The transistors in these cells can be grouped into blocks in the same manner as CMOS logic gates, however their ID strings will not be complementary. In addition there will also be a number of isolated transistors and other similar structures in the layout that will not be part of any transistor block or functional cell derived from the block. These include unique structures such as pass-gates or capacitors.

The entire layout being analysed will consist of a series of different logic gates, cells and transistors that are repeated a large number of times. Once all of the identifiable logic gates, and other cells are replaced by their symbols in the schematic, the schematic illustrated in FIG. 3 may be generated from the updated netlist.

In addition to providing an updated netlist of the circuit, the extraction tool also calculates the size of each logic gate in the schematic. From the coordinates of the transistors located on the layout at diagonally opposite corners of an identified logic gate or cell, the rectangular size of the gate or cell may be determined in microns. This data is included in the netlist and may be fed back to the layout to place borders around the transistors forming the logic gate. In addition, the actual length and width of each transistor in a logic gate may also be inserted into the updated netlist and can be used at a later time in analog analysis of the circuit to determine signal rise and fall times.

As indicated above, a software such as Magic identifies the transistors in a layout and generates a SPICE netlist of all of the transistors and their connections. The gate extractor tool, using CMOS logic rules, carries out a number of steps to identify all of the CMOS logic gates found on the layout to be analysed. The logic gates that are to be identified include inverters, NAND gates, NOR gates as well as the more complex gates. The following are examples of how the gate extraction process operates.

As described above, the first step is to scan the transistor netlist to group the transistors into blocks. A block is defined as being a group of transistors having at least one PMOS transistor and one NMOS transistor connected to one another only through their sources and drains between power and ground nodes. The gates of the transistors of each type are connected to the same input signals and the block has at least one output node which is usually connected to a gate in a further transistor block.

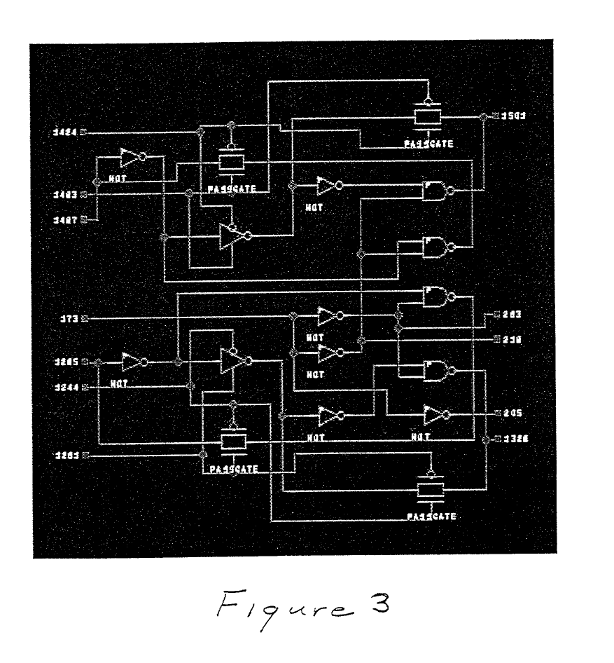

FIG. 4 illustrates one type of transistor block 40 that can be identified when the netlist is scanned. In this case, a p-transistor 44 was selected to initiate the branch identification process 20 since its source is connected to a power node 41. Following process 20 in the FIG. 2 it is found that the sole PMOS transistor 44 is the main PMOS branch. Following the process 20 for transistor 45, it is found that the sole NMOS transistor 45 is the main NMOS branch. The two main branches are connected together at common node 43 which defines the output of the circuit and between the power node 41 and the ground node 42.

The second step in the process is to determine whether the transistor block 40 is complementary; to do so, ID or character strings may be used. Since there is only one p-type transistor 44 in the main PMOS branch, the p-ID string would be “p-O1(V_{A}) where p indicates a p-type transistor string and “O” indicates a parallel branch with 1 transistor and “(V_{A})” indicates the input to the transistor gate. In this particular transistor block, the transistor 45 can be defined as a series branch. The n-ID string would therefore be “n-A1(V_{A}) where n indicates an n-type transistor string and “A” indicates a series branch with 1 transistor and “(V_{A})” indicates the input to the transistor gate.

The complementarity test is whether for every series or parallel branch and/or sub-branch in the main PMOS branch there is a parallel or series branch and/or sub-branch in the main NMOS branch and whether the transistors in these complementary branches have the same inputs. From the p-ID and n-ID strings above, block 40 passes both of these tests since one branch is an “O” and the other branch is an “A” and both transistors have the same input V_{A} as determined from the netlist.

The third step is to identify the CMOS-logic gate block 40 from a library of logic gates or to give the CMOS-logic gate block 40 a name and to generate a symbol for it. In this case, CMOS-logic gate block 40 can be identified as an inverter and therefore can be replaced in the schematic by the symbol 50 illustrated in FIG. 5.

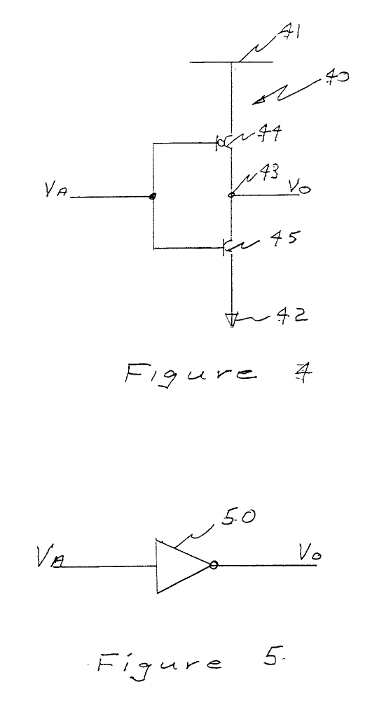

A further transistor block 60 which can be found by scanning the netlist is illustrated in FIG. 6. In searching for series connections (step 22), it is found that transistors 64, 65 and 66 are grouped into a series branch between the power node 61 and common node 63, and that there are no further series branches. Going through steps 25 to 27 in process 20, it is found that there are no parallel branches, and therefore step 28 and 29 determine that the series branch is the main PMOS branch. On the other hand, using process 20 on the NMOS branch determines that there are no series branches. Going through steps 25 to 27 the first time identifies transistor 67 as being a parallel branch with transistor 68 and the second time identifies this parallel branch as being a parallel branch with transistor 69 to form the main NMOS branch connected between the common node 63 and the ground node 62.

Therefore the p-ID string is:

p-A3(V_{A}, V_{B}, V_{C})

and the n-string is:

n-O3(V_{A}, V_{B}, V_{C}).

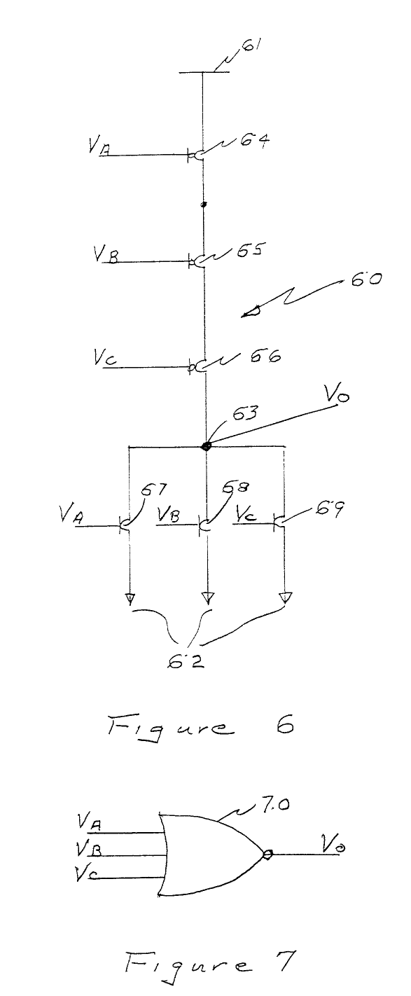

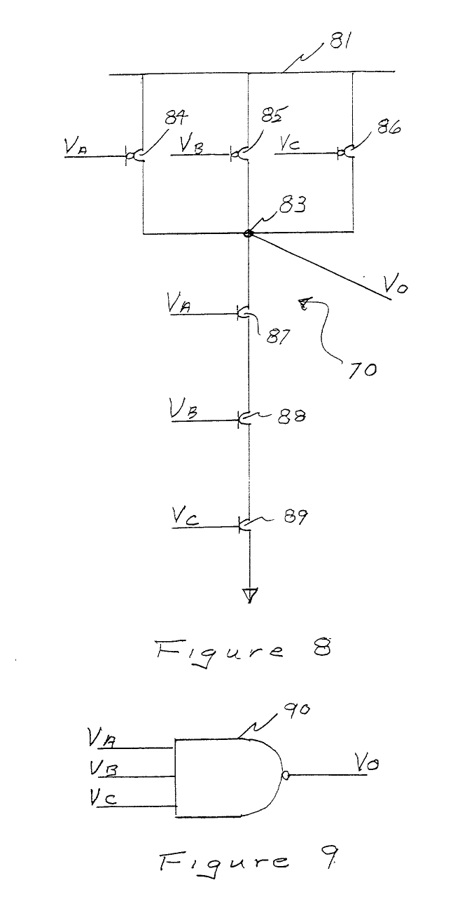

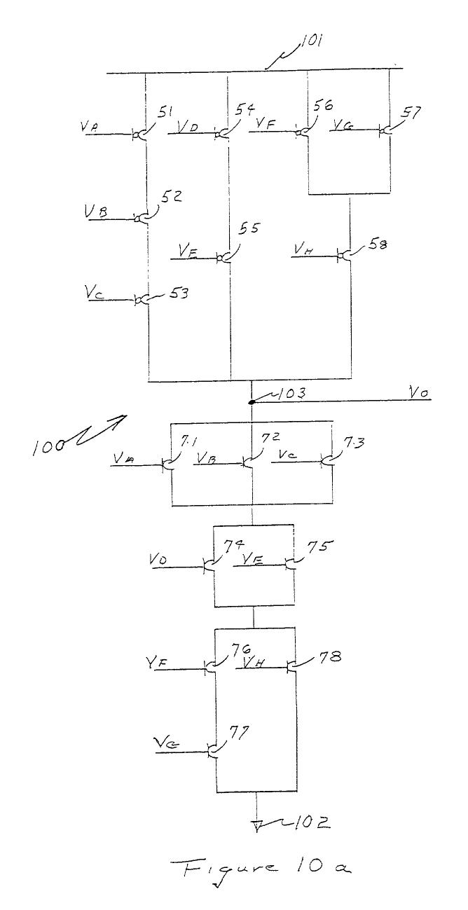

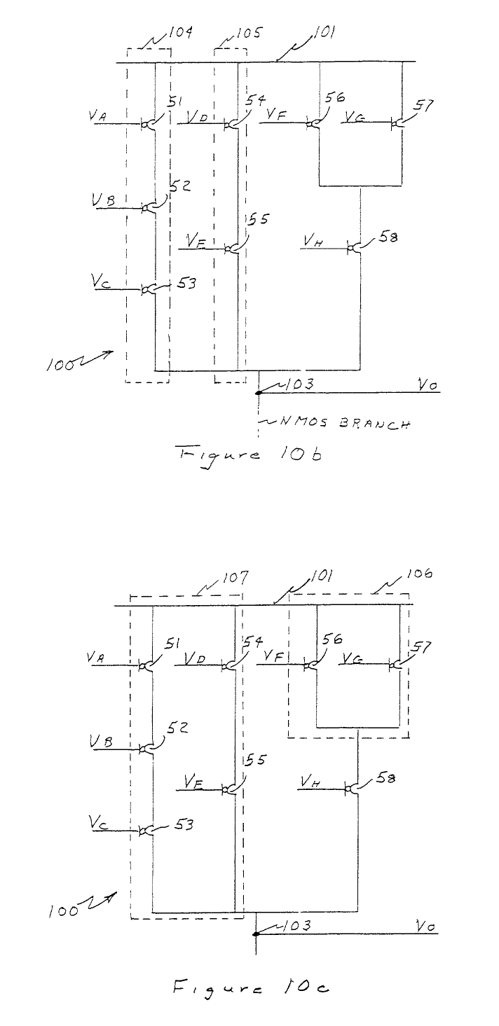

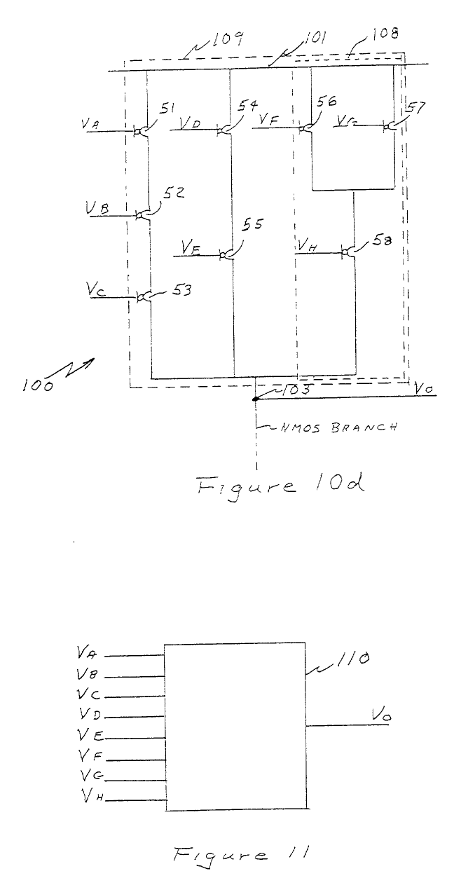

These strings are found to be complementary in that the 3 PMOS transistors 64 to 66 are in series with inputs V_{A}, V_{B}, and V_{C} for the respective PMOS transistors 64 to 66 while the 3 NMOS transistors 67 to 69 are in parallel with the same inputs V_{A}, V_{B}, and V_{C} for the respective NMOS transistors 67 to 69. The block 60 is therefore known to be a CMOS logic gate and can be identified through the library as being a three input NOR gate that can be replaced by the symbol 70 illustrated in FIG. 7.

A further example of a simple transistor block 80 which can be found by scanning the netlist is illustrated in FIG. 8. In this case p-transistor 84, having its source connected to the power node 81, is selected to initiate the branch identification process 20. It is to be noted that any one of transistors 84, 85 or 86 could be selected to initiate process 20 with the same result. In this case, process 20 through steps 22 to 24 will determine that no series branches exist in the PMOS transistor block, however the iterative process through steps 25 to 27 will determine that the main PMOS branch consists of 3 parallel transistors/branches. For the NMOS transistors however, steps 22 to 27 will determine that the NMOS main branch consists of a single series branch. The two main branches are connected together at node 83 between power node 81 and ground node 82.

The p-ID string is:

p-O3(V_{A}, V_{B}, V_{C})

and the n-string is:

n-A3(V_{A}, V_{B}, V_{C}).

These strings are found to be complementary in that the 3 p-transistors 84 to 86 are in parallel with inputs V_{A}, V_{B}, and V_{C} for the respective p-transistors 84 to 86 while the 3 n-transistors 81 to 89 are in series with the same inputs V_{A}, V_{B}, and V_{C} for the respective n-transistors 81 to 89. The block 80 is therefore known to be a CMOS logic gate and can be identified through the library as being a three input NAND gate that can be replaced by the symbol 90 illustrated in FIG. 9.

In scanning the netlist of a project, there may be numerous identical transistor blocks, some as simple as those illustrated above, though others may be more complex. FIG. 10a illustrates a block 100 which includes PMOS transistors 51 to 58 and NMOS transistors 71 to 78, is much more complex, however the main PMOS and NMOS branches are identified in the same manner as described above using the iterative identification process 20 in FIG. 2. The identification process 20 with respect to the PMOS transistors of the complex multi-transistor device 100 will be described in some detail in conjunction with figures 10b, 10c and 10d. The use of process 20 will not be described in detail for the NMOS transistors 71 to 78, however the resulting main branch will be presented.

Starting with transistor 51 which is connected to the power node, through steps 22 and 23, series branch 104 which includes transistors 51 to 53 is identified as shown on FIG. 10b. Decision step 24 will cause a second series search to be done which will identify series branch 105 which includes transistors 54 and 55 also as shown on 10b. Decision step 24 will determine that there are no further serial connections and therefore step 25 initiates the search for parallel branches. The first time through steps 25 and 26, transistors 56 and 57 will be grouped into a parallel branch 106 as shown on figure 10c. The second time through steps 25 and 26, parallel branches 104 and 105 will be grouped into a further parallel branch 107. With no further parallel connections, but still more than one branch, step 28 returns the process to step 22 to search for serial connections. Step 23 groups branch 106 and transistor 58 into a series branch 108 shown on FIG. 10d. With no further series connection, step 24 turns to step 25 to seek a parallel connection. Step 26 groups branch 107 with branch 108 as branch 109 as seen in FIG. 10d. Since all of the transistors are now in a single branch, step 28 ends the process. Branch 109 is the main PMOS branch connected between the power node 101 and the common node 103. Main branch 109 has three series branches connected in parallel with one of the branches having a parallel sub-branch. The ID string for main PMOS branch 109 is:

p-O3{A3(V_{A}, V_{B}, V_{C} )A2(V_{D}, V_{E})A2(V_{H}, O2[V_{F}, V_{G}])}.

When the same iterative process 20 is applied to the NMOS transistors, it is found that the main NMOS branch which is connected between the common node 103 and the ground node 102 consists of three parallel branches connected in series where one of the parallel branches includes a series sub-branch. The ID string for the n-transistors is therefore:

n-A3{O3(V_{A}, V_{B}, V_{C} )O2(V_{D}, V_{E})O2(V_{H}, A2[V_{F}, V_{G}])}.

With block 100 having been defined, the p-and n-ID string can be compared to see if the block 100 is a CMOS logic gate. In comparing the ID strings it is noted that the p-ID string has three parallel branches while the n-ID string has three series branches which is a condition for complementarity. However the same must hold true for the composition of the branches. The p-ID string has a branch with three transistors 51 to 53 in series with inputs V_{A}, V_{B}, V_{C} which complements one of the transistor branches in the n-ID string that has three transistors 71 to 73 in parallel with inputs V_{A}, V_{B}, V_{C} . The p-ID string also has a transistor branch with two transistors 54 and 55 in series with inputs V_{D}, V_{E} which complements one of the transistor branches in the n-ID string that has two transistors 74 and 75 in parallel with inputs V_{D}, V_{E}. Finally, the third branch in the p-ID string consists of two transistors 56 and 57 in parallel with inputs V_{F}, V_{G}which are in series with a third transistor 58 with input V_{H}, this branch complements the third branch in the n-ID string which has two transistors 76 and 77 in series with inputs V_{F}, V_{G}that are in parallel with a transistor 78 with input V_{H}.

This is illustrated in the following comparison:

| p- | b- |
|---|---|
| O3 | A3 |
| A3(V_{A}, V_{B}, V_{C}) | O3(V_{A}, V_{B}, V_{C}) |
| A2(V_{D}, V_{E}) | O2(V_{D}, V_{E}) |
| A2(V_{H}, O2[V_{F},V_{G}]) | O2(V_{H}, A2[V_{F}, V_{G}]) |

Block 100 is therefore a CMOS logic gate which may be represented by the symbol 110 shown in FIG. 11.

There are however some transistor blocks which are found through a scan of the netlist which are not CMOS logic gates. One example of such a block 120 is illustrated in FIG. 12. In this case p-transistor 124 having its source connected to the power node 111 is selected to initiate the identification process 20. In following the process 20 through steps 22 to 24, it is quickly determined that the main PMOS branch consists of transistors 124 and 125 in series between power node 121 and common node 123. Similarly, it is determined that the main NMOS branch consists of transistors 126 and 127 in series between common node 123 and ground node 122. In analysing the ID strings which are:

p-A2(V_{A}, V_{B})

n-A2(V_{B}, V_{C})

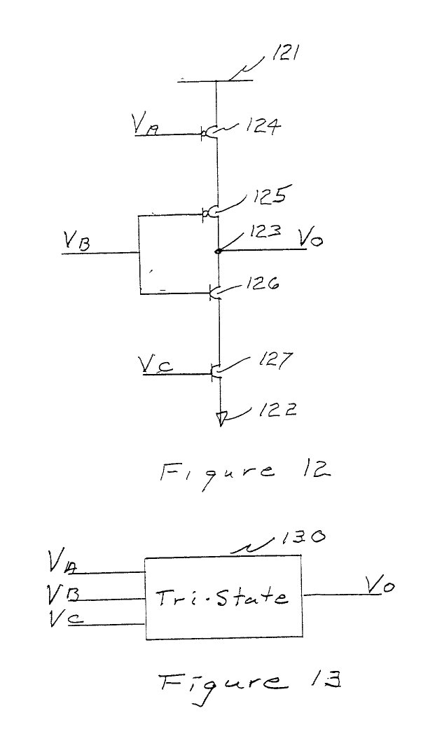

it is found that the strings are not complementary for two reasons. Both branches are series branches and the inputs to the transistors are not the same. The non-complementary transistor block therefore constitutes a functional cell which is not a CMOS logic gate. In this particular case, the device has been defined as being a tri-state device and is represented by the simple box symbol 130 shown in FIG. 13.

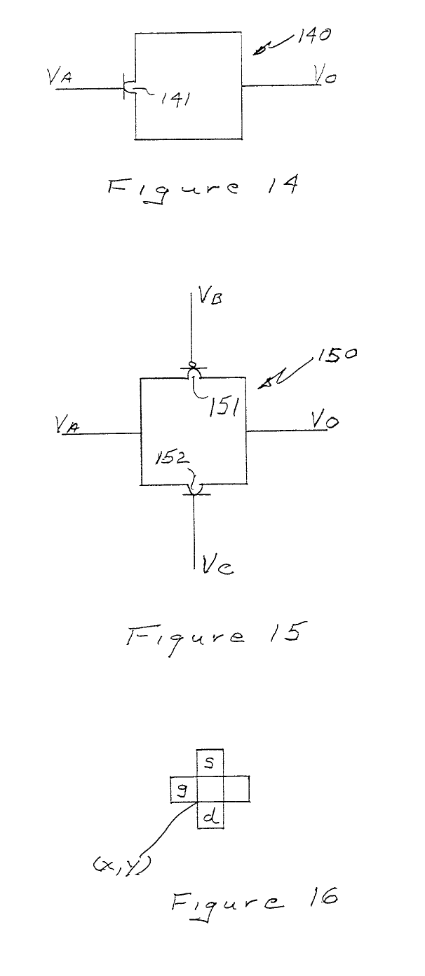

There will be a number of devices in the netlist which cannot be processed since they will not be selected to trace when the netlist is scanned. These devices do not meet the basic criteria since they do not have a transistor whose source or drain is connected to a power node or a ground node. An example of such a device 140 is illustrated in FIG. 14 where a transistor 141 has its source and drain connected together as the output V_{O} to form a capacitor 140 with an input V_{A} connected to the gate.

Another unique device which will not be detected by the scan for transistor blocks is the Pass-Gate 150 illustrated in FIG. 15. In this case the PMOS and NMOS transistors 151 and 152 respectively do not fall within the definition of a transistor block since the sources and drains are not connected to a power node or a ground node. The sources of the two transistors 151 and 152 are connected together and the drains of the two transistors 151 and 152 are connected together such that the passage of the input signal V_{A} as an output V_{O} is controlled by the input signals V_{B} and V_{C} on the gates of transistors 151 and 152.

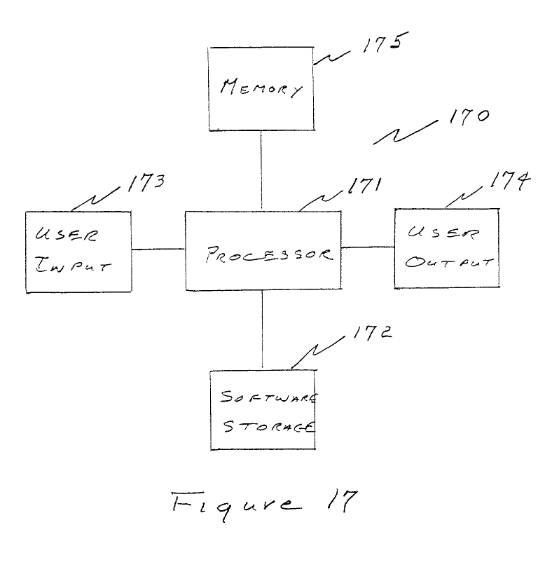

The transistor or SPICE layout data includes two pieces of transistor information that is imported forward to a netlist of the schematic that includes CMOS logic gates, these are the transistor coordinates and the transistor dimensions. For consistency, the x and y coordinates for each transistor are always taken at the same place on the transistor. FIG. 16 illustrates the layers of semiconductor material for one transistor on the layout. For transistors on a layout, the x and y coordinates are always taken as being the bottom left intersection point of the layers. For each logic gate the coordinate data for each transistor is obtained and a routine is used to calculate the boundaries of the logic gate. This is done by identifying the extreme bottom left transistor coordinates and the top right transistor coordinates. This data is inserted into the netlist description of the logic gate and may also be sent back to the layout so that a rectangular outline may be drawn over the layout at the location of the logic gate in question.

The dimensions of the transistors in each logic gate in the netlist are also recorded with the gate for future use. This information is only needed when analog analysis of the gates is desired, such as when rise and fall times of the pulses are required.

The present invention has equal application whether it is applied to an entire layout to be analysed or whether a layout is first divided into a number of more manageable functional sections which then may be analysed sequentially or in parallel.

The above invention may be implemented using a computer system 170 of the type illustrated in FIG. 17. The system includes a processor 171 connected to a software storage device 172 which controls the processor 171, a user input device 173, a user output device 174 and a memory 175 for storing cell data and data generated by the system.

While the invention has been described according to what is presently considered to be the most practical and preferred embodiments, it must be understood that the invention is not limited to the disclosed embodiments. Those ordinarily skilled in the art will understand that various modifications and equivalent structures and functions may be made without departing from the spirit and scope of the invention as defined in the claims. Therefore, the invention as defined in the claims must be accorded the broadest possible interpretation so as to encompass all such modifications and equivalent structures and functions.

What is claimed is:

1. A process for extracting logic gates from a transistor netlist comprising the steps of:
a. scanning the netlist for transistor blocks of p-type and n-type transistors;
b. determining if the p-type transistors and the n-type transistors are complementary; and
c. identifying the logic gate in each of the complementary transistor blocks.

2. The process in claim 1 wherein the transistor block comprises: a group of p-type transistors connected through their sources and drains between a power node and a common node and a group of n-type transistors connected through their sources and drains between a ground node and the common node.

3. The process in claim 2 wherein step (a.) comprises:
a.1. selecting a transistor having a source connected to a power node or a ground node; and
a.2. grouping the transistors of the p-type and of the n-type by tracing the transistor source/drain connections starting from the selected transistor.

4. The process in claim 1 wherein step (b.) comprises:
b.1. identifying the main p-type transistor branch and the main n-type transistor branch; and
b.2. comparing the main branches for complementarity.

5. The process in claim 4 wherein step (b.1.) comprises iteratively seeking the serial connections and the parallel connections for the p-type transistors and the n-type transistors in a transistor block.

6. The process in claim 5 wherein the iterative process for each of the p-type transistors and the n-type transistors comprises:
b.1.1 selecting a start transistor;
b.1.2. searching for serial connections among transistors and branches;
b.1.3 grouping transistors and branches connected in series into a further branch;
b.1.4 repeating step b.1.2 until there are no serial connections left;
b.1.5 searching for parallel connections among transistors and branches;
b.1.6 grouping transistors and branches connected in parallel into a further branch;
b.1.7 repeating step b.1.2 until there are no parallel connections left;
b.1.8 repeat steps b.1.2 to b.1.4 and steps b.1.5 to b.1.7 until there is only one main branch.

7. The process in claim 4 wherein step (b.2.) comprises:
b.2.1. generating an ID-string for the main p-type transistor branch;
b.2.2. generating an ID-string for the main n-type transistor branch; and
b.2.3. comparing the p-ID-string and the n-ID-string for complementarity.

8. The process in claim 7 wherein step (d.) comprises comparing at least one of the p-ID-string and the n-ID-string to the ID-strings of known logic-gates.

9. The process in claim 2 wherein step (d.) comprises:
d.1. generating a netlist for each block of complementary transistor blocks; and
d.2. comparing the complementary transistor block netlists to netlists of known logic gates.

10. A process in a computer system for identifying a logic gate in a transistor netlist comprising:
a. tracing a transistor block of p-type and n-type transistors; and
b. determining the complementarity of the group of p-type transistors and the group of n-type transistors in the transistor block.

11. The process in claim 10 wherein the transistor block comprises: a group of p-type transistors connected through their sources and drains between a power node and a common node and a group of n-type transistors connected through their sources and drains between a ground node and the common node.

12. The process in claim 11 wherein step (a.) comprises:
a.1. selecting a transistor having a source connected to a power or ground node from the netlist; and
a.2. determining the transistors in the p-type and the n-type transistor groups by tracing the transistor source/drain connections starting from the selected transistor.

13. The process in claim 10 wherein step (b.) comprises:
b.1. identifying the main p-type transistor branch and the main n-type transistor branch; and
b.2. comparing the main branches for complementarity.

14. The process in claim 13 wherein step (b.1.) comprises iteratively seeking the serial connections and the parallel connections for the p-type transistors and the n-type transistors in a transistor block.

15. The process in claim 14 wherein the iterative process for each of the p-type transistors and the n-type transistors comprises:
b.1.1 selecting a start transistor;
b.1.2. searching for serial connections among transistors and branches;
b.1.3 grouping transistors and branches connected in series into a further branch;
b.1.4 repeating step b.1.2 until there are no serial connections left;
b.1.5 searching for parallel connections among transistors and branches;
b.1.6 grouping transistors and branches connected in parallel into a further branch;
b.1.7 repeating step b.1.2 until there are no parallel connections left;
b.1.8 repeat steps b.1.2 to b.1.4 and steps b.1.5 to b.1.7 until there is only one main branch.

16. A process as in claim 10 wherein step (b.) comprises:
b.1. generating an ID-string for the p-type transistors in the transistor block;
b.2. generating an ID-string for the n-type transistors in the transistor block; and
b.3. comparing the p-ID-string and the n-ID-string for complementarity.

17. The process in claim 16 wherein step (d.) comprises comparing at least one of the p-ID-string and the n-ID-string to the ID-strings of known logic-gates.

18. The process in claim 11 wherein step (d.) comprises:
d.1. generating a netlist for each block of complementary transistor blocks; and
d.2. comparing the complementary transistor block netlists to netlists of known logic gates.

19. A process for extracting functional cells from a transistor netlist comprising the steps of:
a. scanning the netlist for transistor blocks of p-type and n-type transistors;
b. determining whether the p-type transistors and the n-type transistors are complementary or non-complementary;
c. selecting the complementary transistor blocks;
d. identifying the logic gate in each of the complementary transistor blocks;
e. selecting the non-complementary transistor blocks; and
f. identifying the functional cell in each of the non-complementary transistor blocks.

20. The process in claim 19 wherein the transistor block comprises:
a group of p-type transistors connected through their sources and drains between a power node and a common node and a group of n-type transistors connected through their sources and drains between a ground node and the common node.

21. The process in claim 20 wherein step (a.) comprises:
a.1. selecting a transistor having a source connected to a power or ground node; and
a.2. grouping the transistors of the p-type and the n-type by tracing the transistor source/drain connections starting from the selected transistor.

22. The process in claim 19 wherein step (b.) comprises:
b.1. identifying the main p-type transistor branch and the main n-type transistor branch; and
b.2. comparing the main branches for complementarity.

23. The process in claim 22 wherein step (b.1.) comprises iteratively seeking the serial connections and the parallel connections for the p-type transistors and the n-type transistors in a transistor block.

24. The process in claim 23 wherein the iterative process for each of the p-type transistors and the n-type transistors comprises:
b.1.1 selecting a start transistor;
b.1.2. searching for serial connections among transistors and branches;
b.1.3 grouping transistors and branches connected in series into a further branch;
b.1.4 repeating step b.1.2 until there are no serial connections left;
b.1.5 searching for parallel connections among transistors and branches;
b.1.6 grouping transistors and branches connected in parallel into a further branch;
b.1.7 repeating step b.1.2 until there are no parallel connections left;
b.1.8 repeat steps b.1.2 to b.1.4 and steps b.1.5 to b.1.7 until there is only one main branch.

25. The process in claim 20 wherein step (b.) comprises:
b.1. generating an ID-string for the p-type transistors in the transistor block;
b.2. generating an ID-string for the n-type transistors in the transistor block;
b.3. comparing the p-ID-string and the n-ID-string for complementarity.

26. The process in claim 25 wherein step (d.) comprises comparing at least one of the p-ID-string and the n-ID-string to the ID-strings of known logic-gates.

27. The process in claim 20 wherein step (d.) comprises:
d.1. generating a netlist for each of the complementary transistor blocks; and
d.2. comparing the complementary transistor block netlists to netlists of known logic gates.

28. The process in claim 27 wherein step (d.) further comprises:
d.3. generating symbols representing unknown logic cells; and
d.4. associating the symbols with the complementary transistor block netlists of the unknown logic cells.

29. The process in claim 20 wherein step (f.) comprises:
f.1. generating a netlist for each of the non-complementary transistor blocks; and
f.2. comparing the complementary transistor block netlists to netlists of known functional cells.

30. The process in claim 20 wherein step (f.) comprises:
f.1. generating a netlist describing the functional cell for each of the non-complementary transistor blocks;
f.2. comparing the complementary transistor block netlists to netlists of known functional cells;
f.3. generating symbols representing unknown functional cells; and
f.4. associating the symbols with the complementary transistor block netlists of the unknown functional cells.

31. A process in a computer system for extracting functional cells from a transistor netlist stored within the computer system memory comprising the steps of:
a. scanning the netlist for transistor blocks of p-type and n-type transistors;
b. determining whether the p-type transistors and the n-type transistors are complementary or non-complementary in the computer system processor;
c. selecting the complementary transistor blocks;
d. identifying the logic gate in each of the complementary transistor blocks;
e. selecting the non-complementary transistor blocks; and
f. identifying the functional cell in each of the non-complementary transistor blocks.

32. The process in claim 31 wherein the transistor block comprises: group of p-type transistors connected through their sources and drains between a power node and a common node and a group of n-type transistors connected through their sources and drains between a ground node and the common node.

33. The process in claim 31 wherein step (a.) comprises:
a.1. selecting a transistor having a source connected to a power or ground node; and
a.2. determining the transistors in the p-type and the n-type by tracing the transistor source/drain connections starting from the selected transistor.

34. The process in claim 30 wherein step (b.) comprises:
b.1. identifying the main p-type transistor branch and the main n-type transistor branch; and
b.2. comparing the main branches for complementarity.

35. The process in claim 34 wherein step (b.1.) comprises iteratively seeking the serial connections and the parallel connections for the p-type transistors and the n-type transistors in a transistor block.

36. The process in claim 35 wherein the iterative process for each of the p-type transistors and the n-type transistors comprises:
b.1.1 selecting a start transistor;
b.1.2. searching for serial connections among transistors and branches;
b.1.3 grouping transistors and branches connected in series into a further branch;
b.1.4 repeating step b.1.2 until there are no serial connections left;
b.1.5 searching for parallel connections among transistors and branches;
b.1.6 grouping transistors and branches connected in parallel into a further branch;
b.1.7 repeating step b.1.2 until there are no parallel connections left;
b.1.8 repeat steps b.1.2 to b.1.4 and steps b.1.5 to b.1.7 until there is only one main branch.

37. The process in claim 32 wherein step (b.) comprises b.1. generating an ID-string for the p-type transistors in the transistor block;
b.2. generating an ID-string for the n-type transistors in the transistor block;
b.3. comparing the p-ID-string and the n-ID-string for complementarity in the processor.

38. The process in claim 37 wherein step (d.) comprises comparing at least one of the p-ID-string and the n-ID-string to the ID-strings of known logic-gates.

39. The process in claim 32 wherein step (d.) comprises:
d.1. generating a netlist for each of the complementary transistor blocks;
d.2. storing the generated netlist in the memory; and
d.3. comparing the complementary transistor block netlists to netlists of known logic gates.

40. The process in claim 39 wherein step (d.) further comprises:
d.4. generating symbols representing unknown logic cells;
d.5. storing the symbols in the memory in association with the unknown logic cells.

41. The process in claim 32 wherein step (f.) comprises:
f.1. generating a netlist for each of the non-complementary transistor blocks;
f.2. storing the generated netlist in the memory; and
f.3. comparing the complementary transistor block netlists to netlists of known functional cells.

42. The process in claim 32 wherein step (f.) comprises:
f.1. generating a netlist describing the functional cell for each of the non-complementary transistor blocks;
f.2. storing the generated netlist in the memory
f.3. comparing the complementary transistor block netlists to netlists of known functional cells;
f.4. generating symbols representing unknown functional cells; and
f.5. storing the symbols in the memory in association with the complementary transistor block netlists of the unknown functional cells.
